(19) United States
(12) Patent Application Publication
(10) Pub. No.: US 2012/0235033 A1
(43) Pub. Date: Sep. 20, 2012

(54) DIFFERENTIAL MOBILITY ANALYZER

(76) Inventor: Emilio Ramiro Arcas, Madrid (ES)

(21) Appl. No.: 13/509,037

(22) PCT Filed: Nov. 11, 2009
(86) PCT No.: PCT/ES2009/070493

§ 371 Date: May 10, 2012

(51) Int. Cl. H01J 49/26

(52) U.S. Cl. 250/282; 250/288

(57) ABSTRACT

The object of this invention is a differential mobility analyzer (DMA). Differential mobility analyzers allow classifying charged particles by their electrical mobility. The sample to analyze requires the use of a charging stage, which, in the state of the art, takes place outside of a classification region, so that the sample, once charged, is injected into the classification region of the differential mobility analyzer. Instead, the present invention charges the sample to analyze inside the classification region, to eliminate the time elapsing between the generation of the charged particles and their arrival to the classification region, resulting in a reduction in the time available for the ions to recombine. The invention improves the results obtained as recombination of the charged particles makes the results unreliable.

### OBJECT OF THE INVENTION

The object of this invention is a differential mobility analyser (DMA). Differential mobility analysers allow classifying charged particles or ionised molecules according to their electrical mobility. The sample to analyse requires a stage for ionising the molecules or charging the particles which, in the state of the art, is performed out of the classification region, such that once the sample is ionised or charged it is injected into the classification region of the differential mobility analyser.

Instead, the present invention performs the ionisation or charging of the sample to analyse inside the analyser, in order to eliminate the time elapsed between the generation of the charged particles or ionised molecules and their entry in the classification region. This reduces the time available for the ions to recombine, potentially increasing in size by aggregation for example with water, or colliding against the internal walls of the instrument, and thus losing their charge. The invention improves the results obtained as recombination, aggregation or collision of charged particles or ionised molecules affects the quality of the results.

### BACKGROUND OF THE INVENTION

Several models of differential mobility analysers (DMA) are known in the state of the art meant to obtain a high resolution in the discrimination of charged particles or ionised molecules (which we will refer to under the common term “charged particles”) according to their electrical mobility.

The basic principle used in a differential mobility analyser is to establish a carrier flow through a main conduct where a “classification region” is located, in which the flow crossing it has conditions that are as laminar as possible.

This classification region is subjected in the working mode to an electric field that crosses the carrier flow transversally, so that any charged particles present within the classification region will be subjected to two forces, one due to the carrier flow and another due to this electric field. Throughout the description, and specifically also in the figures, the longitudinal direction will refer to the main direction of the carrier flow and the transverse direction will refer to the perpendicular direction essentially coinciding with the direction of the electric field.

The direction of the electric field is said to essentially coincide with the transverse direction because the inclination of the electric field may be modified, for example to improve resolution or to produce an additional effect on the measurements made with the analyser.

If the electric field is generated, for example, with two electrodes placed face to face and leaving the classification region between them, the injection of charged particles on one side of the classification region will result in a set of trajectories, the path of which will depend on the electrical mobility of these particles.

The carrier flow will push the particles down-stream and the electric field will carry the charged particles transversally according to their electrical mobility. In this way, depending on its electrical mobility each charged particle, under the influence of the electrical field, will impact sooner or later along the longitudinal axis. The position of impact of the charged particle will determine its mobility and allow its classification.

One of the most basic configurations of differential mobility analysers known in the state of the art is described in the PCT patent application with publication number WO03041114, which is based on a cylindrical symmetry. The injection is performed through a peripheral slit and detection is also performed at a slit present on the outer assembly.

Other patent applications, such as those with publication numbers WO2007020303 and WO2008003797 respectively make use of a planar or bi-dimensional configuration. Specifically, the latter application (WO2008003797) also incorporates an oblique electrical field that allows improving the resolution of the device.

In all of the aforementioned cases, as well as in documents WO 94/16320, U.S. Pat. No. 5,455,417, U.S. Pat. No. 5,047,723 and U.S. Pat. No. 7,339,162, the injection of the sample to analyse in the classification region is performed when the particles contained in the sample have already been charged. The charging operation is performed before the sample reaches the classification region.

When the sample particles are charged, they must be transported to the classification region. Transportation takes place by what is referred to in this description as the sample secondary flow, the flow rate of which is lower than the main carrier flow rate.

Since the ions are generated out of the classification region and must be transported to this region by the flow in which they are immersed, the time of permanence from the time the charged particle is generated until this particle enters the classification region is of the same order as the lifetime of the charged particle. Charged particles show a great affinity for recombination, and can grow in size by aggregation with, for example, water or collide with the inner walls of the instrument, losing their charge and producing particles that are different from those present in the original sample to analyse. Therefore, recombination produces unreliable results as the readings may correspond to particles other than those originally introduced in the analyser, corresponding instead to particles modified by recombination, in addition lowering their concentration as losses occur due to the changes that take place in their path, which results in a reduced sensitivity.

The present invention establishes a differential mobility analyser that solves these drawbacks by generating the charged particles when the particles are already introduced in the classification region, dramatically reducing the time of residence that gives rise to recombination of the charged particles.

### DESCRIPTION OF THE INVENTION

The present invention consists of a differential mobility analyser that comprises the following elements:
A main duct for passage of a carrier flow, wherein this main duct is provided in its interior with a classification region.
   This duct can be open or closed. If it is closed it has the advantage of allowing re-circulation in well-controlled conditions. This is the flow mainly responsible for carrying the particle. The classification region is the analysis region that is under the influence of the electric field, establishing different trajectories depending on electrical mobility. This classification region depends on the specific configuration of the analyser and typically consists of a control volume defined between two sections of the main duct through which the carrier flow passes. This is the case in both cylindrical and bi-dimensional or planar configurations. In bi-dimensional or planar configurations the velocity front is essentially planar, except for the effects of the walls. The electric field is essentially linear and homogenous at all points between the electrodes that generate the electric field, except at their edges.
A secondary flow inlet to the main duct for injecting the uncharged sample to analyse.
   The secondary flow inlet is what allows introducing the particles to analyse. Unlike the case in the state of the art, the particles to analyse are not charged; instead, these particles are charged inside the main duct.
Means for generating an electric field in the classification region where, in working mode, the electric field is essentially transverse to the direction of the carrier flow that runs in the classification region.
   The electric field displaces the charged particles or ionised molecules (referred to from now globally simply as charged particles) transversally through the main duct depending on their electrical mobility. The electric field is essentially transverse to the direction of the carrier flow as it can have deviations from this transverse direction, for example, to increase its sensitivity by using an oblique field. The electric field is generally generated by a suitable disposition of polarised electrodes opposite each other.
Means for determining or discriminating the electrical mobility of the charged particles carried by the electric field.
   Once the charged particles have reached the side opposite that established by the direction of the carrier electric field, it is possible to determine their electrical mobility according to the distance travelled downstream in the direction of the carrier flow, or to perform a discrimination based on whether a specified position is reached also downstream in the direction of the carrier flow.
   In the first case the distance travelled can be determined by sensors, such as multi-line sensors, that detect the impact of the charged particle. The electrical mobility can be determined from the distance travelled downstream.
   In the second case, a reference value is used to discriminate which particles have a greater or lower electrical mobility value. When a slit is placed at this position it is possible to extract the particle with an electric mobility value equal to that of the reference value, which is that corresponding to a trajectory that reaches the slit. Extracting these particles allows, for example, performing subsequent analyses with the particles or storing them.
Differentiation from the state of the art in that the charging methods provided are such that in the working mode the charging takes place in the classification region, allowing the charged particles to separate as soon as they are formed, this region being reached by all or part of the secondary flow after entering the main duct.
   The secondary flow that carries the sample with the particles to analyse enters the main duct, which is where the charging takes place. The technical advantage is that when the particles of the secondary flow are charged they are already in the classification region, without having to remain for a permanence time in an external charger, which would lead to recombination of charged particles as occurs in the devices known in the state of the art.

The secondary flow is introduced through an inlet that leads to the main duct. The examples of embodiments executed seek conditions of both the carrier flow and the secondary flow such that:
The carrier flow is as laminar as possible and has a high Reynolds number;
The secondary flow remains adjacent to the wall and runs downstream, establishing two parallel flows in the area where it meets the main flow;
The means for charging the particles are located in the wall downstream of the inlet point of the secondary flow, so that its region of influence is crossed by part or all of the secondary flow. In this way, particles of the secondary flow are charged which when subjected to the electric field are driven as occurs in electrical mobility analysers. The invention does not necessarily require all of the particles introduced to be charged.

The fact that the inlet of the secondary flow is located upstream of the classification region in the direction of the carrier flow means that a constant cross section of the secondary flow is obtained along the entire classification region, preventing any turbulence from being generated.

It is not necessary to inject the secondary flow upstream of the classification region, but directly in it, although this may lead to difficulties in practical execution as it is necessary for the inlet of the secondary flow and the ionisation area to coincide, which may result in the appearance of turbulence at high main flow rates.

It is important to control the variables that determine the two flows to avoid producing turbulence and so that the second flow is guided by the carrier flow, reaching the region of influence of the charging means.

As the particles are charged in the classification region, the electric fields do not affect the sample until it is inside the classification region. This allows generating the electric field for classifying the particles by either establishing the ground potential in the exit electrode and the high potential in the entry electrode or vice versa. Keeping the potential of the exit electrode at ground is useful for using a charging device that must be grounded. Keeping the entry electrode potential at ground is useful for detecting particles with a device that must be grounded.

In the examples of embodiment of the invention used by way of example for a description in greater detail, specific modes are also incorporated that present additional technical advantages.

Considered as incorporated by this description are the embodiments defined by dependent claims 2 to 12.

### DESCRIPTION OF THE DRAWINGS

The present descriptive memory is completed by a set of drawings illustrating an example of a preferred embodiment and in no way limiting the invention.

FIG. 1 shows a schematic representation of a first example of embodiment of the invention characterised in that it adopts a bi-dimensional configuration, also known as a planar configuration.

FIG. 2 shows a schematic representation of a second example of embodiment of the invention characterised in that it incorporates a charging mode based on the use of a charging vector that is injected in the classification region.

### DETAILED DESCRIPTION OF THE INVENTION

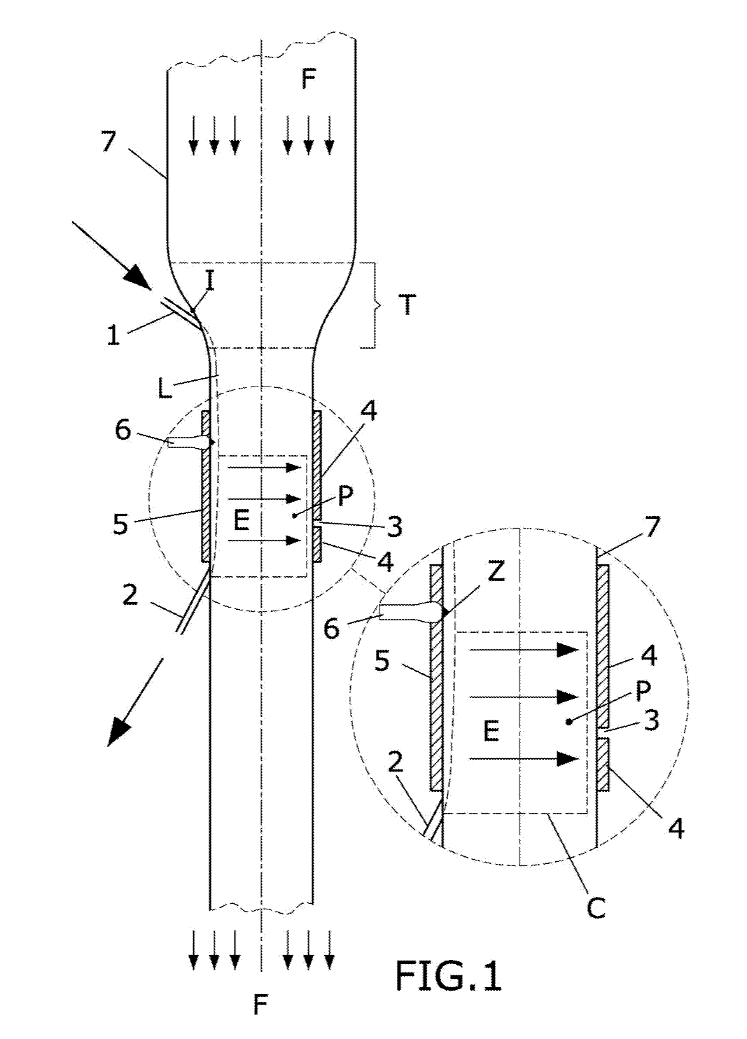

FIG. 1 shows a schematic representation of a first example of embodiment of the invention in which a segment of the main duct (7) is represented. In this example a main duct (7) describing a closed circuit is used, although only the segment of interest in which the classification region (C) is located is shown.

The main duct (7) carries the carrier flow (F). As in the differential mobility analysers known in the state of the art, before reaching the classification region it is convenient to incorporate filters to keep clean the carrier flow (F) and filters to ensure a laminar flow, preventing the appearance of turbulence in the classification region (C).

The segment of the main duct (7) shown is the one containing the classification region (C), which corresponds to a narrowing meant to accelerate the carrier flow (F). In this example of embodiment the configuration of the main duct (7) is essentially bi-dimensional. It is described as essentially bi-dimensional because the cross-section is rectangular and it is possible that variations in cross-section occur not only in the directions contained in the plane represented in the drawing, but also in the perpendicular direction (on the other sides of the rectangle of the cross-section). Typically, this type of configuration is also known as planar. Specifically, the configuration of the narrowing in the cross-section shown in FIG. 1 begins with a converging nozzle (T) in which it is possible to identify a point of inflection (I) in the curvature that establishes the variation in cross-section along the longitudinal axis.

It is also possible to execute the invention using cylindrical configurations, as used in the state of the art.

The converging nozzle (T) accelerates the flow rate and reduces pressure. The existence of negative pressure gradients in the longitudinal direction of the nozzle (T) also favours the stability of the boundary layer and prevents the appearance of turbulence, specifically by preventing the detachment of the boundary layer.

A secondary flow (L) is injected through a second inlet (1) that in this example of embodiment exits at the nozzle (T) of the main duct (7); specifically, after the point of inflection (I). This secondary flow consists of the sample to analyse and carries particles (P), not necessarily charged.

The secondary flow (L), once it is in the main duct (7), runs adjacent to the wall of said duct (7). Numerical simulations have allowed to determine the dimensions of the inlet (1) of the secondary flow (L), as well as the flow rates of both the carrier flow (F) and the secondary flow (L) for which the secondary flow remains adjacent to the wall at least until reaching the area downstream where the charging means (6) are located, and more specifically the classification region (C). Each step must be adjusted numerically and there are many parameters affecting the optimum conditions for achieving this adequate transport of the secondary flow (L); however, it has been found that these conditions are accomplished more easily if the inlet (1) of the secondary flow (L) is located after the point of inflection (I) of the curve defined by the convergence of the nozzle (T).

Once the secondary flow (L) has reached the region (Z) of influence of the charging means (6), these will act to charge the particles (P) that can be charged.

One embodiment of the invention uses a radioactive source that can emit alpha or beta short-range radiation. Another embodiment of the invention uses a source of ionising radiation, ultraviolet or X-ray radiation, preferably focussed with a lens.

The charged particles (P), charged by the charging means (6), are already either at the inlet of the classification region (C) or inside the classification region (C), thereby eliminating a time of residence that could lead to recombination, which leads to unreliable results as occurs in the devices described in the state of the art.

In this first example of embodiment the classification region (C) has a rectangular-base prism shape, limited laterally by the walls of the main duct (7), while its upper and lower base (according to the position represented for the analyser in FIG. 1) correspond to limits of the control volume through which enters and exits respectively the flow resulting from the sum of the carrier flow (F) and the secondary flow (L).

Also according to the orientation shown in FIG. 1, the classification region (C) is limited laterally by the electrodes (4, 5) which, when polarised in the working mode, establish an electric field (E) essentially transverse to the carrier flow (F).

The carrier flow (F) will transport the charged particles (P) downstream along the longitudinal direction, while the electric field (E) will carry these same particles (P) transversally from left to right until they reach the wall. The greater the electrical mobility of the charged particle (P), the sooner it will hit the wall on the right and thus the higher the arrival point.

As described in the state of the art, the invention can use charge sensors that can determine the arrival point, or two electrodes can be fitted to determine whether the particle impacts above or below a given reference position.

It is also possible to incorporate a slit (3) that allows the charged particle (P) to exit when it has the electrical mobility corresponding to the reference value used when calibrating the apparatus [modifying the intensity of the electric field (E) and the conditions of the carrier flow (F)] so that it coincides with the slit (3). The charge particle (P) thus extracted can in turn enter other apparatuses with greater precision or can be stored for subsequent processing.

A specific embodiment of the invention incorporates a drain outlet for the secondary flow (F) after the classification region (C). In this case it is convenient to also establish flow conditions such that the secondary flow (F) remains stably adjacent to the wall until it reaches the outlet (2). In the examples of embodiment the outlet is subjected to a pressure lower than the pressure at the outlet point (2) to favour a suction action on the flow (F).

The stability of the secondary flow (F) and its permanence adjacent to the wall have been improved by establishing an oblique inlet (1) with an inclination that brings the direction of the input secondary flow (F) towards the direction of the carrier flow (F) at the inlet point. In the example of embodiment, a 45° angle is used with respect to the longitudinal direction, thereby reducing the likelihood of re-circulation occurring in the inlet area (1) at the wall downstream of this inlet (1).

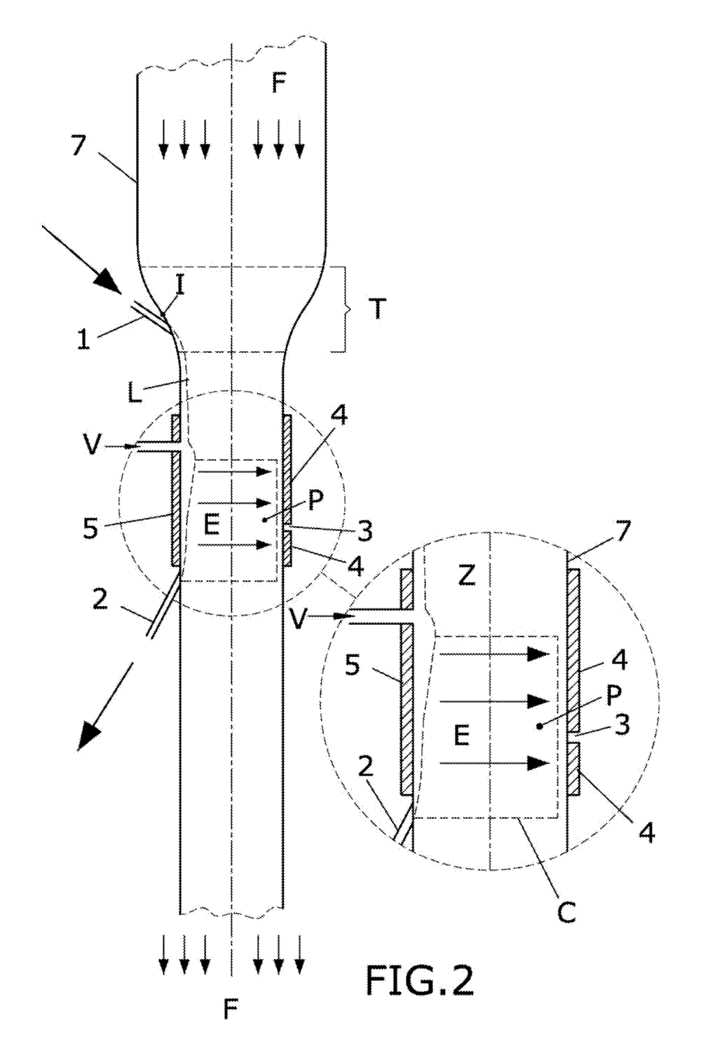

FIG. 2 corresponds to a second example of embodiment in which charging is performed inside the main duct (7), incorporating the input of a charged flow (V) that acts as a charge vector for charging the secondary flow (L) that contains the sample to be analysed.

The charged flow (V), acting as a vector transfers its charge to the particles of the secondary flow (L), thereby charging it.

The charged particles (P) in the classification region (C) will behave in the manner described above.

Regardless of the configuration used in the analyser, the analysis procedure according to the present invention is established by the stages of claim 11, which is included by reference in this description.

What is claimed is:

1. A differential mobility analyzer comprising:
a main duct (7) for passage of a carrier flow (F), wherein this main duct (7) is provided in its interior with a classification region (C);
a secondary flow inlet (1) to the main duct (7) for injecting an uncharged sample to be analyzed;
means (4, 5) for generating an electric field (E) in the classification region (C) where, in working mode, the electric field (E) is essentially transverse to the direction of the carrier flow (F) that runs in the classification region (C);
means (3) for determining or discriminating the electrical mobility of the charged particles (P) or ionized molecules carried by the electric field (E);
the mobility analyzer is provided with charging means (6) such that in working mode they perform this charging in the classification region (C), which is reached by all or part of the secondary flow (L) after it enters the main duct (7).

2. The analyzer according to claim 1 wherein the secondary flow inlet (1) is located upstream of the classification region (C) in the direction of the carrier flow (F).

3. The analyzer according to claim 1 wherein the main duct (7) has a narrowing in which the classification region (C) is located.

4. The analyzer according to claim 3 wherein the narrowing is provided upstream with a convergent nozzle (T) with a longitudinal cross-section having a point of inflection (I) such that the inlet (1) of the secondary flow (L) is downstream of this point of inflection (I).

5. The analyzer according to claim 2 wherein the secondary flow inlet (1) has a configuration such that in the working mode it establishes a secondary flow (L) adjacent to the wall of the main duct (1), at least until the point where this secondary flow (L) reaches the classification region (C).

6. The analyzer according to claim 5 wherein the secondary flow inlet (1) has a configuration such that it establishes a secondary flow (F) in the point of entry to the main duct (1) that is oblique and oriented toward the direction of the carrier flow (F).

7. The analyzer according to claim 1 further comprising a drainage outlet (2) after the classification region (C) for removing all or part of the secondary flow (L) from the carrier flow (F).

8. The analyzer according to claim 1 wherein the charging means (6) is a radioactive source, or an ionizing radiation source preferably focused by optical means, or both.

9. The analyzer according to claim 1 wherein the charging means (6) comprise the entry of a flow (V) which in working mode contains a charge vector, wherein this entry is disposed such that the injection of this flow (V) with the charge vector impacts on the secondary flow (L) with the sample to be analyzed in order to charge it.

10. The analyzer according to claim 1 wherein the means (3) for discriminating the electrical mobility of the charged particles (P) carried by the electric field (E) consists of a slit (3) located at a position downstream of a charging region (Z) that can be reached by the charged particles (P) that correspond to a predetermined electrical mobility.

11. The analyzer according to claim 1 wherein the means (3) for discriminating the electrical mobility of the charged particles (P) carried by the electric field (E) consists of one or more sensors located at a position downstream of a charging region (Z) that can be reached by the charged particles (P), either to determine their electrical mobility or to discriminate by electrical mobility according to the impact position of the charged particles (P).

12. A method for analyzing the electric mobility of a sample containing particles that can be charged, comprising the steps of:
establishing a carrier flow (F) in the main duct (7) which is incorporated as a secondary flow (L) of the sample containing the particles that can be charged and establishing conditions for both flows such that the secondary flow is transported adjacent to the wall of the main duct (7);
charging the secondary flow (L) in a region (Z) located inside the classification region (C) of the main duct (7);
directing the carrier flow (F) together with the secondary flow (L) containing the charged particles (P) to pass through an essentially transverse electric field (E) to subsequently discriminate the charged particles (P) according to their electrical mobility.
